(19) United States
(12) Patent Application Publication
(10) Pub. No.: US 2014/0378133 A1
(43) Pub. Date: Dec. 25, 2014

(54) METHOD AND SYSTEM FOR PROVIDING FLOW MOBILITY IN A DISTRIBUTED MOBILITY MANAGEMENT NETWORK

(71) Applicant: Foundation of Soongsil University-Industry Cooperation, Seoul (KR)

(72) Inventors: Young Han Kim, Seoul (KR); Kyoung Jae Sun, Seoul (KR)

(73) Assignee: Foundation of Soongsil University-Industry Cooperation, Seoul (KR)

(21) Appl. No.: 14/080,186

(22) Filed: Nov. 14, 2013

(30) Foreign Application Priority Data
Jun. 25, 2013 (KR) 10-2013-0072960

(51) Int. Cl. H04W 36/00; H04W 8/22

(52) U.S. Cl. CPC H04W 36/0022; H04W 8/22
USPC 455/436

(57) ABSTRACT

A method and system for providing flow mobility in a distributed mobility management network are disclosed. The method of controlling data flow mobility can include: (a) receiving session information in correspondence to a connection to each mobile access router from said mobile access router and storing the session information, which may include terminal information, an allotted address, and data flow information; (b) determining a target data flow to be moved by analyzing the session information according to a flow movement policy; and (c) transmitting a flow movement request, which includes the allotted address corresponding to the determined target data flow, to a new mobile access router.

### CROSS-REFERENCE TO RELATED APPLICATIONS

This application claims the benefit of Korean Patent Application No. 10-2013-0072960, filed with the Korean Intellectual Property Office on Jun. 25, 2013, the disclosure of which is incorporated herein by reference in its entirety.

### BACKGROUND

1. Technical Field

The present invention relates to a distributed mobility management network, more particularly to a method and system for providing flow mobility in a distributed mobility management network that manages information on flows sent and received by a terminal, together with information on the terminal, so as to be able to move data flows corresponding to the terminal even when the terminal connects with several interfaces.

2. Description of the Related Art

Distributed mobility management is a technology in which distributed anchors are used for mobility management with their functions performed only when mobility is needed. When a terminal connects to a mobile access router, the mobile access router may operate as a regular router while the terminal is not moving, and when the terminal is moved, a tunnel is created between the previously connected mobile access router and the newly connected mobile access router to maintain the session and allow communication.

According to the related art, when a terminal undergoes a handover, the newly connected mobile access router may allocate a new address to the terminal, and at the same time, create a tunnel by performing perform proxy binding with the mobile access router to which the terminal was previously connected. Thus, packets arriving at the previous address of the terminal may be forwarded to the new mobile access router, so that a session may be maintained.

However, conventional techniques define call flow procedures for data flow mobility only for cases in which the terminal uses a single communication interface, and not for cases in which the terminal uses multiple communication interfaces.

### SUMMARY

An aspect of the invention is to provide a method and system for providing flow mobility in a distributed mobility management network by which a data flow can be moved to another interface in the distributed mobility management network without having the terminal change the IP address or generate a separate signaling message.

One aspect of the invention provides a method for providing flow mobility in a distributed mobility management network by which a data flow can be moved to another interface in the distributed mobility management network without having the terminal change the IP address or generate a separate signaling message.

An embodiment of the invention provides a method of controlling data flow mobility that can include: (a) receiving session information in correspondence to a connection to each mobile access router from said mobile access router and storing the session information, which may include terminal information, an allotted address, and data flow information; (b) determining a target data flow to be moved by analyzing the session information according to a flow movement policy; and (c) transmitting a flow movement request, which includes the allotted address corresponding to the determined target data flow, to a new mobile access router.

The flow movement policy can be determined in consideration of at least one of a traffic level, a network operator policy, and a network status.

The allotted address can include an address of an anchor mobile access router for the connection, and the new mobile access router can create a tunnel using the address of the anchor mobile access router by performing proxy binding with the anchor mobile access router to complete the flow mobility.

The method can further include renewing the terminal information and the allotted address included in the session information upon receiving a message of completion of the flow mobility from the new mobile access router.

For the operation of receiving and storing the session information, the terminal can be implemented with a multiple number of communication interfaces, and can connect to mobile access routers supporting the communication interfaces sequentially or simultaneously by using the multiple communication interfaces.

The communication interfaces can include a Wi-Fi and 3G/4G communication interface.

Another aspect of the invention provides a system for providing flow mobility in a distributed mobility management network by which a data flow can be moved to another interface in the distributed mobility management network without having the terminal change the IP address or generate a separate signaling message.

An embodiment of the invention provides a session management apparatus for controlling the data flow mobility of a terminal, where the session management apparatus can include: a session manager unit configured to receive session information, in correspondence to a connection by the terminal to each mobile access router, from said mobile access router for said connection, and configured to store the session information, which may include terminal information, an allotted address, and data flow information; an analyzer unit configured to determine a target data flow to be moved by analyzing the session information according to a flow movement policy; and a control unit configured to provide control such that a flow movement request, which may include the allotted address corresponding to the determined target data flow, is transmitted to a new mobile access router.

The allotted address can include an address of an anchor mobile access router for the connection, and the new mobile access router can create a tunnel using the address of the anchor mobile access router by performing proxy binding with the anchor mobile access router to complete the flow mobility.

The session manager unit can renew and store the terminal information and the allotted address included in the session information, upon receiving a message of completion of the flow mobility from the new mobile access router.

Another embodiment of the invention provides a system for providing flow mobility that can include: a session management apparatus configured to receive and store session information in correspondence to a connection by a terminal to each mobile access router, receiving the session information from said mobile access router for said connection, and configured to determine a target data flow to be moved by analyzing the session information according to a flow movement policy; and a mobile access router configured to create a tunnel by performing proxy binding with an anchor mobile access router to complete the flow mobility upon receiving a flow movement request, which may include an allotted address corresponding to the determined data flow, from the session management apparatus.

The session information can include terminal information, an allotted address, and data flow information for a connection of the terminal to a mobile access router at an anchor point through each communication interface, and the allotted address can include an address of an anchor mobile access router corresponding to the data flow.

The session management apparatus can transmit a flow movement request for the target data flow including the address of the anchor mobile access router to the mobile access router and can renew the terminal information and the allotted address stored in the session information upon receiving a message of mobility support completion from the mobile access router.

By virtue of the method and system for providing flow mobility in a distributed mobility management network according to an embodiment of the invention, a data flow can be moved to another interface in the distributed mobility management network without having the terminal change the IP address or generate a separate signaling message.

Also, in certain embodiments of the invention, the session management apparatus may manage the terminal information, allotted address, and data flow information for each session and may provide a function for managing data flow movement policies, making it possible to move data flows without additional signaling messages between mobility access routers, and thereby providing the advantages of reduced delay time and reduced packet loss rate.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 schematically illustrates a system for providing flow mobility in a distributed mobility management network according to an embodiment of the invention.

FIG. 2 and FIG. 3 illustrate examples of tables storing terminal information, allotted addresses, and data flow information for connections to mobility access routers through the respective communication interfaces in a terminal according to an embodiment of the invention.

FIG. 4 is a flow diagram illustrating the procedures by which a terminal makes connections is allotted with addresses through interfaces with mobile access routers that support such interfaces in a distributed mobility management network according to an embodiment of the invention.

FIG. 5 is a flow diagram illustrating a method of moving a data flow in a terminal according to an embodiment of the invention.

FIG. 6 schematically illustrates the internal composition of a session management apparatus according to an embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

While such terms as “first” and “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In an embodiment of the invention, a distributed mobility management network may manage the terminal information, the address allotted to the terminal, and the data flow information sent or received by the terminal together for each session, making it possible to move a data flow to another interface in the distributed mobility management network without requiring that the terminal change the IP address or generate a separate signaling message.

Certain embodiments of the invention are described below in more detail with reference to the accompanying drawings.

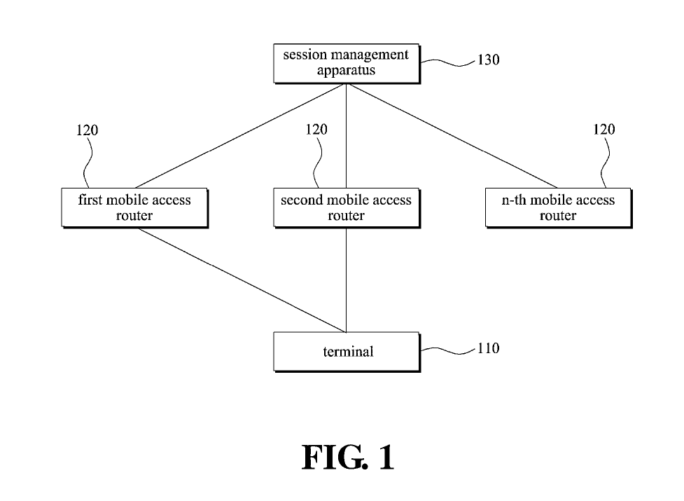

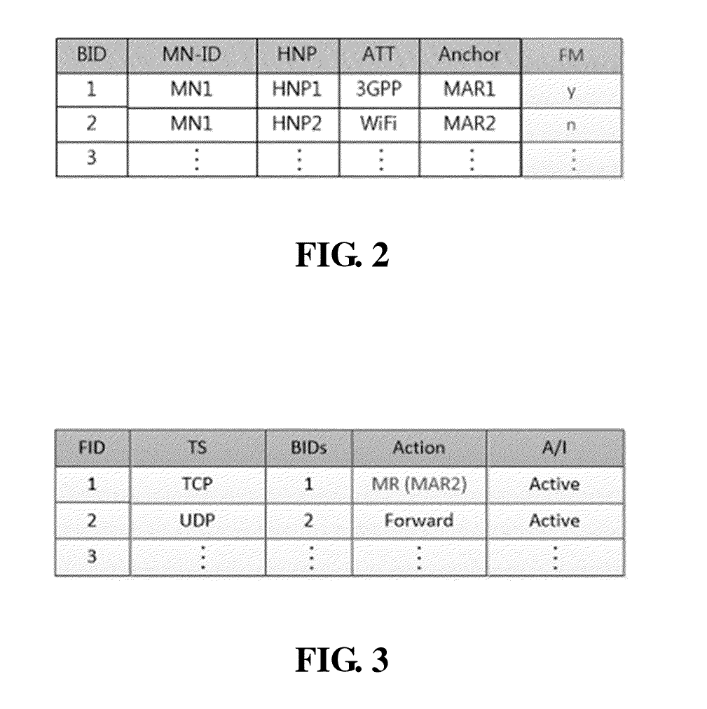

FIG. 1 schematically illustrates a system for providing flow mobility in a distributed mobility management network according to an embodiment of the invention, and FIG. 2 and FIG. 3 illustrate examples of tables storing terminal information, allotted addresses, and data flow information for connections to mobility access routers through the respective communication interfaces in a terminal according to an embodiment of the invention.

Referring to FIG. 1, a system for providing flow mobility according to an embodiment of the invention may include a terminal 110, a multiple number of mobile access routers 120, and a session management apparatus 130.

The terminal 110 is a means for connecting to the mobile access routers 120 by using multiple communication interfaces to send and receive data flows. For example, the terminal 110 can be a mobile communication terminal. For example, the communication interfaces can include Wi-Fi, 3G/LTE, etc. For better understanding and easier explanation, the present disclosure uses Wi-Fi and 3G/LTE as examples of communication interfaces, but it is obvious that a communication interface can be any interface that allows IP-based communication. That is, a method of providing flow mobility in a distributed mobility management network according to an embodiment of the invention can be applied in the same manner as long as the terminal 110 is equipped with multiple communication interfaces that allow IP-based communication.

In the present disclosure, a data flow refers to the data being sent or received between the terminal 110 and a server (not shown) or another terminal.

The terminal 110 may use the communication interfaces to sequentially or simultaneously connect to the respective mobile access routers 120 that support the communication interfaces and may be allotted with addresses. Using the allotted addresses, the terminal 110 can generate several data flows to perform communication.

A mobile access router 120 may be an anchor point for each communication interface of the terminal 110 and may serve as a means for supporting the data flow mobility of the terminal 110.

For example, while the terminal 110 sends and receives data to and from the same mobile access router 120 continuously, the mobile access router 120 can operate as a regular router without providing mobility support. However, when the terminal is moved and connects to another mobile access router (referred to herein as a “new mobile access router” for convenience) the mobile access router 120 can create a tunnel with the corresponding new mobile access router to provide mobility support for the data flows of the terminal 110.

The session management apparatus 130 may serve to store and manage session information for each session when a connection is made to each mobile access router through a respective communication interface of the terminal 110. Here, the session information can include terminal information regarding the terminal connected to each mobile access router, the allotted address, and data flow information regarding the data flow sent and received by the terminal.

Also, the session management apparatus 130 can analyze the session information and manage data flow mobility according to the flow mobility policy. Here, the flow mobility policy can include, for example, at least one of a traffic level, a network operator policy (e.g. policies for free-of-charge or paid services), and a network status.

For example, suppose that the communication interfaces of the terminal include the Wi-Fi and the LTE communication interfaces. Typically, the data flows can be communicated much faster when the Wi-Fi communication interface is used. However, if many people suddenly connect to Wi-Fi within a small area, the LTE communication interface can be significantly faster than the Wi-Fi communication interface.

In such a case, the session management apparatus 130 can consider the traffic level for Wi-Fi communication and the traffic level for the LTE communication interface and can move data flows corresponding to the Wi-Fi communication interface to use the mobile access router corresponding to the LTE communication interface.

FIG. 2 and FIG. 3 illustrate examples in which the session management apparatus 130 stores and manages the terminal information, allotted addresses, and data flow information for connections to mobile access routers through the respective communication interfaces of the terminal 110 in the form of tables.

In the example shown in FIG. 2, the terminal information and allotted addresses for connections to mobile access routers through the respective communication interfaces of the terminal 110 are stored and managed in a binding cache table. Here, one or more of terminal identification information, an allotted address, a network access type, the address of the anchor mobile access router, and information on whether or not flow mobility is supported can be stored and managed. The binding cache table can additionally store various other information regarding the terminal or the communication interfaces of the terminal.

FIG. 3 shows an example of a flow mobility cache table storing data flow information, where the service type, movement action, etc., of data flows used by the terminal may be stored and managed.

While FIG. 2 and FIG. 3 illustrate examples in which it is supposed that the session management apparatus 130 stores and manages the terminal information, allotted addresses, and data flow information for connections to the respective mobile access routers through the respective communication interfaces of the terminal 110 in multiple tables, it is obvious that the information can also be stored in a single table.

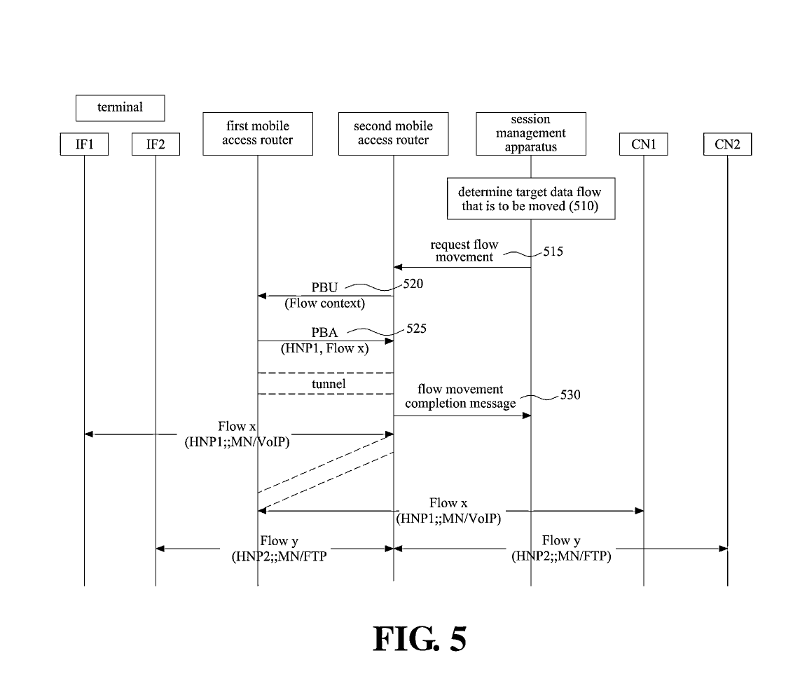

The session management apparatus 130 can analyze the session information corresponding to the connections to the mobile access routers through the respective communication interfaces of the terminal 110, such as those illustrated in FIG. 2 and FIG. 3, to determine the target data flow that is to be moved according to a preset flow mobility policy, and can transmit a flow movement request to a new mobile access router. Here, the flow movement request can include information on the target data flow and the address of the anchor mobile access router. Accordingly, the new mobile access router transmit a proxy binding update message to the corresponding anchor mobile access router by using the address of the anchor mobile access router included in the corresponding flow movement request, to thereby create a tunnel. This will be described below in more detail in the description associated with FIG. 5.

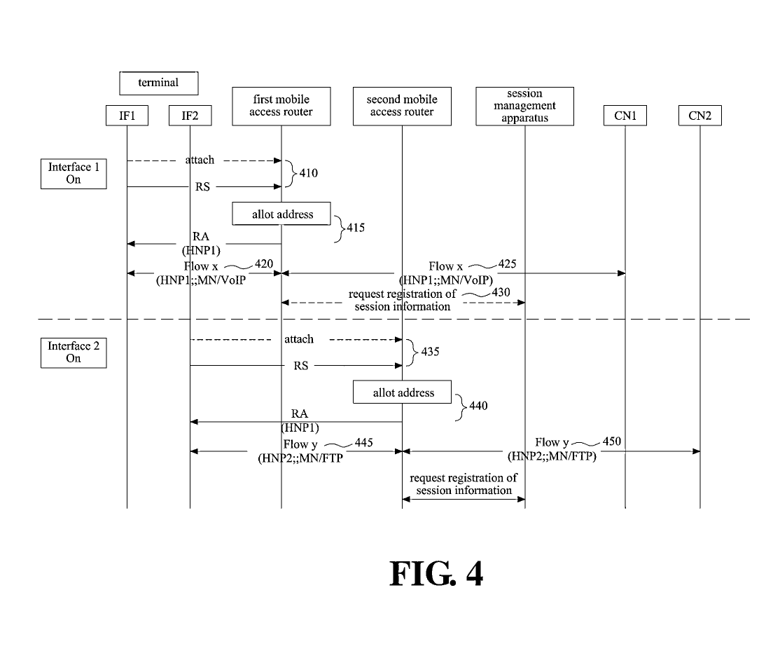

FIG. 4 is a flow diagram illustrating the procedures by which a terminal makes connections is allotted with addresses through interfaces with mobile access routers that support such interfaces in a distributed mobility management network according to an embodiment of the invention.

In operation 410, the terminal 110 may transmit a connection request to a first mobile access router through a first communication interface.

Accordingly, in operation 415, the first mobile access router may allot an address and transmit it to the terminal 110.

In operation 420, the terminal 110 may use the allotted address to generate a data flow and transmit it to the first mobile access router.

Accordingly, in operation 425, the first mobile access router may transmit the data flow received from the terminal 110 to the core network.

Also, in operation 430, the first mobile access router may transmit the terminal information, allotted address, and data flow information received from the terminal 110 to the session management apparatus 130 and request registration.

Accordingly, the session management apparatus 130 may store and manage the terminal information, allotted address, and data flow information in correspondence to the connection to the first mobile access router of the terminal 110 through the first communication interface.

In operation 435, the terminal 110 may request a connection to a second mobile access router through a second communication interface.

Accordingly, in operation 440, the second mobile access router may allot an address and transmit it to the terminal 110.

In operation 445, the terminal 110 may use the allotted address to generate a data flow and transmit it to the second mobile access router.

Accordingly, in operation 450, the second mobile access router can transmit the data flow received from the terminal 110 via the core network to a server (not shown).

Also, in operation 455, the second mobile access router may transmit the terminal information, allotted address, and data flow information received from the terminal 110 to the session management apparatus 130 and request registration.

Accordingly, the session management apparatus 130 may store and manage the terminal information, allotted address, and data flow information in correspondence to the connection to the second mobile access router of the terminal 110 through the second communication interface.

As described above, the terminal can connect to each mobile access router that supports a respective interface and be allotted an address, which can be used by the terminal in generating a data flow and communicating. While FIG. 4 is described for the sake of convenience by using an example in which it is supposed that each interface of the terminal connects to the respective mobile access router sequentially, to be allotted with an address for generating a data flow, it is also possible for each interface of the terminal to connect to the respective mobile access router simultaneously, to be allotted with an address and using the address to generate a data flow and perform communication.

A method by which the terminal in this state moves a first data flow is described below with reference to FIG. 5.

FIG. 5 is a flow diagram illustrating a method of moving a data flow in a terminal according to an embodiment of the invention.

In operation 510, the session management apparatus 130 may analyze the stored session information to determine the target data flow that is to be moved according to the flow mobility policy. Here, the flow mobility policy can be at least one of the traffic level, network status, and network operator policy for the communication interfaces, as already described above.

In operation 515, the session management apparatus 130 may transmit a flow movement request to the new mobile access router, where the flow movement request may include information on the target data flow that was determined to be moved and the address of the anchor mobile access router. Here, the anchor mobile access router may be the mobile access router for an anchor point corresponding to the target data flow that is to be moved, and can be the previous mobile access router.

In operation 520, the new mobile access router that has received a flow movement request from the session management apparatus may transmit a proxy binding update (PBU) message to the anchor mobile access router in order to form a tunnel through proxy binding with the anchor mobile access router for moving a flow.

Then, in operation 525, the anchor mobile access router may transmit an acknowledgement of receiving the proxy binding update message, i.e. a proxy binding acknowledgement (PBA), to the new mobile access router.

Accordingly, a tunnel may be created between the new mobile access router and the anchor mobile access router.

When this procedure for tunnel creation is completed, in operation 530, the new mobile access router may transmit a data flow movement completion message to the session management apparatus.

In operation 530, the session management apparatus 130 may update and store the terminal information stored in the session information in accordance with the receiving of the data flow movement completion message from the new mobile access router.

For example, the session management apparatus 130 can change and update the anchor mobile access router to be the new mobile access router in correspondence with the movement of the target data flow.

By the above procedure, a data flow can be transmitted to another interface of the terminal by way of a tunnel between the first mobile access router and the second mobile access router.

Thus, by having the session management apparatus manage the terminal information, allotted addresses, and data flow information for each session, and by providing a function of managing data flow mobility policy, it is possible to move a data flow without an additional signaling message between mobility access routers, and thus there are provided the advantages of reduced delay time and reduced packet loss rate.

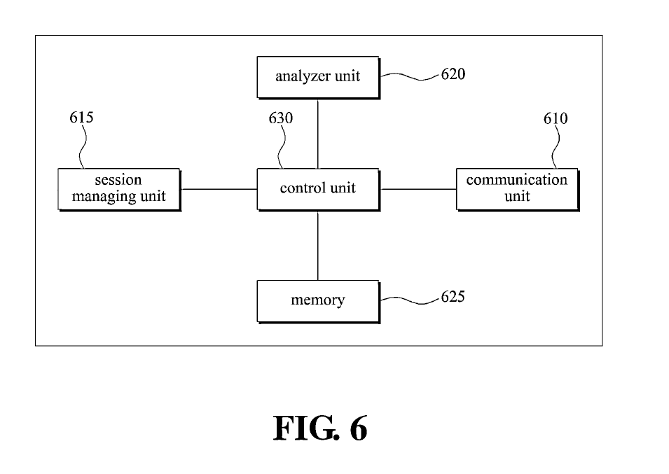

FIG. 6 schematically illustrates the internal composition of a session management apparatus according to an embodiment of the invention.

Referring to FIG. 6, a session management apparatus 130 according to an embodiment of the invention may include a communication unit 610, a session manager unit 615, an analyzer unit 620, a memory 625, and a control unit 630.

The communication unit 610 may be a unit that enables the sending and receiving of data over a communication network to and from other devices (e.g. mobile access routers that support the respective communication interfaces).

For example, the communication unit 610 can receive session information corresponding to a connection through each communication interface of the terminal 110 from the respective mobile access router 120. Also, the communication unit 610 can transmit a flow movement request message to a new mobile access router in accordance with the control of the control unit 630.

The session manager unit 615 may store and manage the session information received by way of the communication unit 610. As described above with reference to FIG. 2 and FIG. 3, the session manager unit 615 may store and manage the terminal information, allotted addresses, and data flow information for the connections of the mobile access routers that support the respective communication interfaces by way of a multiple number of tables.

The analyzer unit 620 may analyze the session information stored and managed by the session manager unit 615 to determine the target data flow that is to be moved according to a preset flow movement policy.

For example, the analyzer unit 620 can determine the data flow that is to be moved according to the flow movement policy (the target data flow) in consideration of at least one of a traffic level, network status, and network operator policy.

For example, the analyzer unit 620 can consider the traffic levels, and if the traffic levels rapidly decrease, a decision can be made by which a data flow corresponding to the communication interface of the user's terminal that requires a particular fee according to the network operator's policy is moved to communicate by having the anchor point set to a mobile access router corresponding to another communication interface with a relatively low traffic level.

The memory 625 may store various algorithms required for operating a session management apparatus 130 according to an embodiment of the invention. The memory 625 may also store the session information (e.g. the binding cache table, flow mobility cache table).

The control unit 630 may serve to control the internal components (e.g. the communication unit 610, session manager unit 615, analyzer unit 620, memory 625, etc.) of a session management apparatus 130 based on an embodiment of the invention.

Also, the control unit 630 can control the movement of a target data flow that is selected for movement by the analyzer unit 620. For example, the control unit 630 can provide the control to extract from the session information the target data flow information and the anchor mobile access router address for the target data flow selected for movement, and to generate a flow movement request message containing such information and transmit it to a new mobile access router.

Also, if a response to the flow movement request message (e.g. a flow movement completion message) is received from the new mobile access router, the control unit 630 can update and store the terminal information stored in the session information.

A method for data flow mobility in a distributed mobility management network according to an embodiment of the present invention can be implemented in the form of program instructions that may be performed using various computer means and can be recorded in a computer-readable medium. Such a computer-readable medium can include program instructions, data files, data structures, etc., alone or in combination.

The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a device for electronically processing information, such as a computer for example, through the use of an interpreter, etc.

The hardware mentioned above can be made to operate as one or more software modules that perform the actions of the embodiments of the invention, and vice versa.

While the present invention has been described above using particular examples, the skilled person would understand that various modifications and alterations can be made without departing from the spirit and scope of the invention as defined by the scope of claims set forth below.

What is claimed is:

1. A method of controlling data flow mobility, the method comprising:
(a) receiving and storing session information, the session information received in correspondence to a connection to each mobile access router from said mobile access router, the session information including terminal information, an allotted address, and data flow information;
(b) determining a target data flow to be moved by analyzing the session information according to a flow movement policy; and
(c) transmitting a flow movement request to a new mobile access router, the flow movement request including the allotted address corresponding to the determined target data flow.

2. The method of claim 1, wherein the flow movement policy is determined in consideration of at least one of a traffic level, a network operator policy, and a network status.

3. The method of claim 1, wherein the allotted address includes an address of an anchor mobile access router for the connection,
and the new mobile access router creates a tunnel using the address of the anchor mobile access router by performing proxy binding with the anchor mobile access router to complete the flow mobility.

4. The method of claim 3, further comprising:
renewing the terminal information and the allotted address included in the session information upon receiving a message of completion of the flow mobility from the new mobile access router.

5. The method of claim 1, wherein, in said receiving and storing,
the terminal is implemented with a plurality of communication interfaces, and connects to mobile access routers supporting the communication interfaces sequentially or simultaneously by using the plurality of communication interfaces.

6. The method of claim 5, wherein the communication interfaces include a Wi-Fi and 3G/4G communication interface.

7. A recorded medium readable by a digital processing device, tangibly embodying a program of instructions executable by the digital processing device to perform a method according to any one of claim 1 through claim 6.

8. A session management apparatus for controlling data flow mobility of a terminal, the session management apparatus comprising:
a session manager unit configured to receive and store session information in correspondence to a connection by the terminal to each mobile access router, the session manager unit receiving the session information from said mobile access router for said connection, the session information including terminal information, an allotted address, and data flow information;
an analyzer unit configured to determine a target data flow to be moved by analyzing the session information according to a flow movement policy; and
a control unit configured to provide control such that a flow movement request is transmitted to a new mobile access router, the flow movement request including the allotted address corresponding to the determined target data flow.

9. The session management apparatus of claim 8, wherein the allotted address includes an address of an anchor mobile access router for the connection,
and the new mobile access router creates a tunnel using the address of the anchor mobile access router by performing proxy binding with the anchor mobile access router to complete the flow mobility.

10. The session management apparatus of claim 9, wherein the session manager unit renews and stores the terminal information and the allotted address included in the session information upon receiving a message of completion of the flow mobility from the new mobile access router.

11. A system for providing flow mobility, the system comprising:
a session management apparatus configured to receive and store session information in correspondence to a connection by a terminal to each mobile access router and configured to determine a target data flow to be moved by analyzing the session information according to a flow movement policy, the session management apparatus receiving the session information from said mobile access router for said connection; and
a mobile access router configured to create a tunnel by performing proxy binding with an anchor mobile access router to complete the flow mobility, upon receiving a flow movement request from the session management apparatus, the flow movement request including an allotted address corresponding to the determined data flow.

12. The system for providing flow mobility of claim 11, wherein the session information includes terminal information, an allotted address, and data flow information for a connection of the terminal to a mobile access router at an anchor point through each communication interface,
and the allotted address includes an address of an anchor mobile access router corresponding to the data flow.

13. The system for providing flow mobility of claim 12, wherein the session management apparatus transmits a flow movement request for the target data flow to the mobile access router, the flow movement request including the address of the anchor mobile access router, and renews the terminal information and the allotted address stored in the session information upon receiving a message of mobility support completion from the mobile access router.
